(19) United States
(12) Patent Application Publication
(10) Pub. No.: US 2026/0239255 A1
(43) Pub. Date: Aug. 13, 2026

(54) TIME SYNCHRONIZATION WITHOUT POSITIONING INFORMATION

(71) Applicant: Sony Group Corporation, Tokyo (JP)

(72) Inventors: Fredrik RUSEK, Eslöv (SE); Johan HILL, Lund (SE); Erik BENGTSSON, Eslöv (SE)

(21) Appl. No.: 19/153,555

(22) PCT Filed: Jan. 23, 2024
(86) PCT No.: PCT/EP2024/051541

§ 371 Date: Aug. 4, 2025

(30) Foreign Application Priority Data
Feb. 17, 2023 (SE) 2350189-3

(51) Int. Cl. H04W 56/00

(52) U.S. Cl. CPC H04W 56/0065; H04W 56/001

(57) ABSTRACT

Examples provide a method performed by an operating node of a communication network, the communication network comprising a plurality of communication nodes including the operating node, the method comprising: obtaining, from at least six of the communication nodes, a message indicative of a time of flight of a reference signal received by the respective communication node from the other communication nodes, and providing, to at least one of the six communication nodes, a message indicative of a clock error estimate of the at least one of the six. Further examples provide a method performed by a wireless communication device of a communication network. In addition, examples disclose an operator node comprising control circuitry, wherein the control circuitry is configured to perform the method described above and a wireless communication device comprising control circuitry, wherein the control circuitry is configured to perform the method disclosed above.

### TECHNICAL FIELD

Various examples generally relate to time synchronization in a communication network.

### BACKGROUND

Positioning performed in communication networks typically relies on good time synchronization. Time synchronization means that the different communication nodes of a communication network, in particular communication nodes which are participating in positioning, use a same clock reference for determining a point in time of receiving or transmitting the one or more reference signals in cellular 3rd Generation Partnership Project (3GPP) based communication networks, a wireless devices (also called user equipment, UE) may synchronize its internal clock with an access node (AN) of the communication network (for example, the gNodeB, gNB), with another UE (for example, Sidelink Mode 2 as specified in 3GPP TS 38.859) or using GNSS assistance (for example, using 3GPP NTN as specified in 3GPP TS 38.300).

The synchronization aims to calibrate the internal clock to the external reference clock to have a good timing alignment between the transmitter and the receiver of a signal communicated in the communication network. Good timing synchronization is particularly important for wireless localization techniques. An error of only 3 ns in time may result in an error of around 1 m in geographical position. Proper synchronization is not only important for communication networks as developed by the 3GPP, but also for other access technologies such as those based on the IEEE 802.11 family of standards (WiFi) and those using ultra-wideband radio technologies (UWB).

NR Sidelink as discussed in 3GPP 38.859 may be designed for three main coverage scenarios: in-coverage, partial-coverage, and out-of-coverage. In the in-coverage scenario, all UEs have a direct connection to a gNB. In the partial-coverage scenario, some UEs have a direction connection to a gNB and some UEs have an indirect connection to a gNB, i.e. some UEs are accessing a gNB using a UE in direct connection with a gNB (e.g. a relay UE). Lastly in the out-of-coverage scenario, the UEs are not able to connect to any gNB but are in connection with each other.

In the out-of-coverage scenario, synchronization between the UEs may be performed without any external reference clock source, but with a UE taking the role as coordinator (cluster head) of the cluster of UEs. After the initial cluster setup, all UEs having synchronized their internal clocks assist in providing synchronization for unsynchronized UEs. Complete cluster synchronization relies on the transmission of synchronization signal blocks (SSBs) between UEs starting from the UE taking the role as cluster head stepwise further away to the other UEs of the cluster.

NR Sidelink (SL) positioning in general requires multiple positioning reference signal (PRS) transmitters to enable the measuring (receiving) UE to perform positioning using time difference of arrival (TDOA) measurements.

For NR V2X, the concept of road side units or Positioning Reference Units (PRU) is proposed to assist other UEs. As an example, for SL-TDOA-based positioning, it may be that three nearby PRUs transmit SL-PRSs toward the UE within a given time window. The UE receives the SL-PRSs, measures the timing delays, and calculates the corresponding timing differences (TDOAs). Similarly other techniques are used such as Round Trip Time (RTT), and Time of Flight (ToF). Positioning is also specified in 3GPP TS 37.355.

Insufficient synchronization of communication nodes participating in positioning may lead to propagation time measurement errors and finally to positioning inaccuracies as explained hereinbefore.

### SUMMARY

Hence, there may be a need for an improved method performed by an operating node of a communication network facilitating a better synchronization of communication nodes of the communication network.

Said need has been addressed with the subject-matter of the independent claims. Advantageous examples are specified in the dependent claims.

Examples provide a method performed by an operating node of a communication network, the communication network comprising a plurality of communication nodes including the operating node, the method comprising: obtaining, from at least six of the communication nodes, a message indicative of a time of flight of a reference signal received by the respective communication node from the other communication nodes, and providing, to at least one of the six communication nodes, a message indicative of a clock error estimate of the at least one of the six.

Further examples provide a method performed by a wireless communication device of a communication network, the communication network comprising a plurality of communication nodes including the wireless communication device and an operator node, the method comprising: upon receiving a reference signal, transmitting another reference signal; and providing, to the operator node, a message indicative of a time of flight of the received reference signal, wherein the message indicative of a time of flight of a reference signal is indicative of a time difference between the point in time of receiving the reference signal and a point in time of transmitting the another reference signal.

In addition, examples disclose an operator node comprising control circuitry, wherein the control circuitry is configured to perform the method described above and a wireless communication device comprising control circuitry, wherein the control circuitry is configured to perform the method disclosed above.

### BRIEF DESCRIPTION OF THE DRAWINGS

FIG. 1 schematically illustrates a communication network comprising an AN and a UE;

FIG. 2 schematically illustrates a communication network comprising six UEs;

FIGS. 3 to 6 schematically illustrates an arrangement of communication nodes

FIG. 7 is a signaling diagram;

FIG. 8 is a signaling diagram; and

FIG. 9 illustrates deriving round trip times.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between nodes. A wireless communication system includes a transmitter node and one or more receiver nodes. In some examples, the wireless communication system can be implemented by a wireless communication network, e.g., a radio-access network (RAN) of a Third Generation Partnership Project (3GPP)-specified cellular network (NW). In such case, the transmitter node can be implemented by an access node (AN), in particular, a base station (BS), of the RAN, and the one or more receiver nodes can be implemented by terminals (also referred to as user equipment, UE). It would also be possible that the transmitter node is implemented by a UE and the one or more receiver nodes are implemented by an AN and/or further UEs. Hereinafter, for the sake of simplicity, various examples will be described with respect to an example implementation of the transmitter node by one or more ANs and the one or more receiver node by UEs—i.e., to downlink (DL) communication; but the respective techniques can be applied to other scenarios, e.g., uplink (UL) communication and/or sidelink communication.

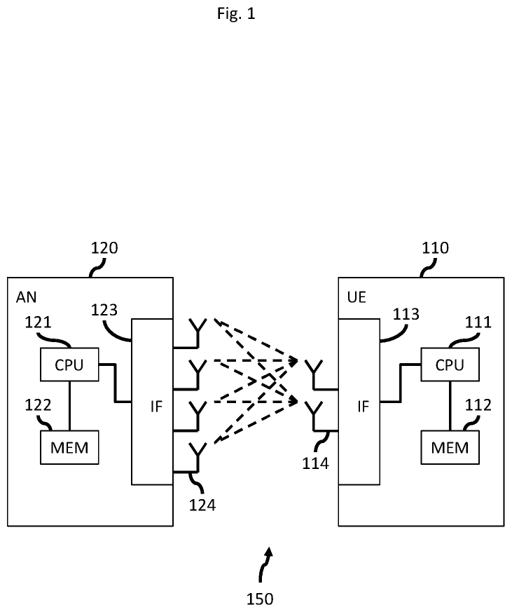

FIG. 1 illustrates details with respect to communication nodes of a communication network 150, in particular with respect to an AN 120 and a UE 110. The AN 120 includes control circuitry that is implemented by a processor 121 and a non-volatile memory 122. The processor 121 can load program code that is stored in the memory 122. The processor 121 can then execute the program code. Executing the program code causes the processor to perform techniques as described herein. The UE 110 includes control circuitry that is implemented by a processor 111 and a non-volatile memory 112. The processor 111 can load program code that is stored in the memory 112. The processor can execute the program code. Executing the program code causes the processor to perform techniques as described herein.

Further, FIG. 1 illustrates details with respect to communication between the AN 120 and the UE 110 on a radio channel. The AN 120 includes an interface 123 that can access and one or more antennas 124. Likewise, the UE 110 includes an interface 113 that can access and control one or more antennas 114.

While the scenario of FIG. 1 illustrates the antennas 124 being coupled to the AN 120, as a general rule, it would be possible to employ transmit-receive points (TRPs) that are spaced apart from the AN 120. The interfaces 113, 123 can each include one or more transmitter (TX) chains and one or more receiver (RX) chains. For instance, such RX chains can include low noise amplifiers, analogue to digital converters, mixers, etc. Analogue and/or digital beamforming would be possible.

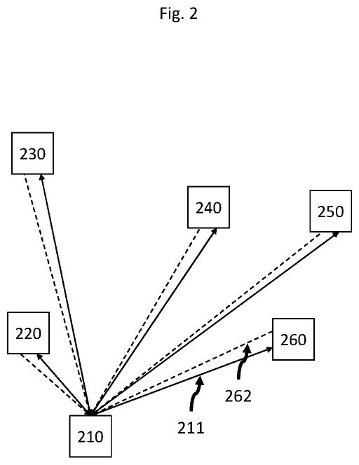

FIG. 2 schematically illustrates a communication network comprising K communication nodes 210, 220, 230, 240, 250, 260 with unknown positions. Each of the K communication nodes 210, 220, 230, 240, 250, 260 may have a stable and systematic internal clock error of an amount ϵₖ which is to be estimated. In particular, the internal clock error may be random and may have a non-zero mean value ϵₖ. The precise, actual value of the internal clock error may not be known.

dᵢⱼ may denote the distance between communication nodes i and j. In a sequential manner, each of the K communication nodes 210, 220, 230, 240, 250, 260 may transmit a reference signal, like the reference signal 211 (shown with a solid line). The other K−1 communication nodes may receive said reference signal 211, process it, and transmit response signals (shown with a dashed line) like the response signal 262 after a pre-defined duration T₀. Each of the K communication nodes may then measure the RTT of its reference signal 211, 221, 231, 241, 251, 261 via the respective other of the K−1 communication nodes using the point in time of transmission of its reference signal 211, 221, 231, 241, 251, 261 and the point in time of reception of the respective response signals.

Considering no further sources of errors beside the internal clock errors ϵₖ, the measurement RTTᵢⱼ corresponding to the RTT between the communication nodes i and j may be expressed as follows

$${RTT}_{ij} = \frac{2 {d}_{i j}}{c} + {T}_{0} + {ϵ}_{i} + {ϵ}_{j}$$

Without loss of generality, T₀ may be selected as T₀=0. Further, since RTTᵢⱼ=RTTⱼᵢ in the absence of noise and assuming that only measurements where j>i are available, RTTᵢⱼ becomes

$${RTT}_{ij} = \frac{2 {d}_{i j}}{c} + {ϵ}_{i} + {ϵ}_{j} + {n}_{i j} , 1 \leq i \leq j \leq K$$

where nᵢⱼ is noise. The goal is to estimate the (unknown) K variables ϵₖ considering that the positions of the K communication nodes and, thus, the K(K−1)/2 distances dᵢⱼ are unknown, too. At first, this seems challenging because only K(K−1)/2 measurements are available. However, it has been found that the distances dᵢⱼ are not independent and this property can be used for estimating the K internal clock errors ϵₖ.

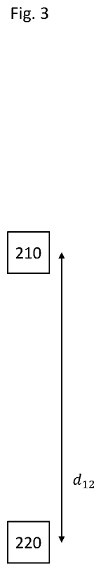

FIGS. 3 to 6 illustrate how the degrees of freedom among the K(K−1)/2 distances dᵢⱼ in a two dimensional plane may be determined. The communication node 210 may be provided at an arbitrary physical location.

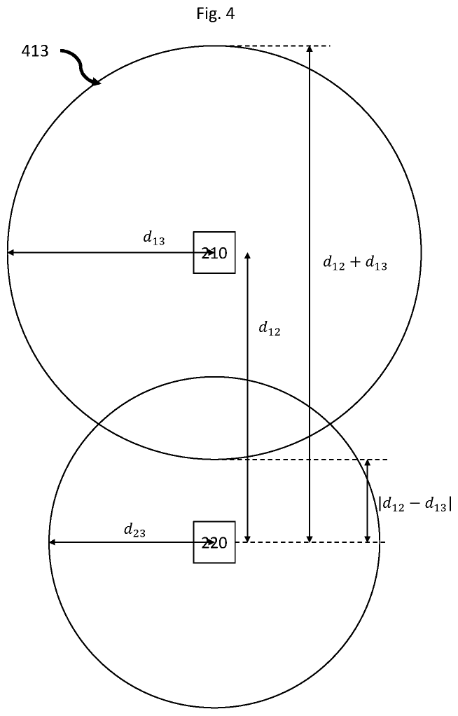

The distance d₁₂ between the communication nodes 210 and 220 is totally free to select. The angular direction from the communication node 210 to the communication node 220 may be unknown. Likewise, the distance d₁₃ between the communication nodes 210 and 230 may be selected at will, i.e. anywhere on the circle 413. However, as shown in FIG. 4, given the distances d₁₂ and d₁₃, d₂₃ is constrained to |d₁₂−d₁₃|≤d₂₃≤d₁₂+d₁₃.

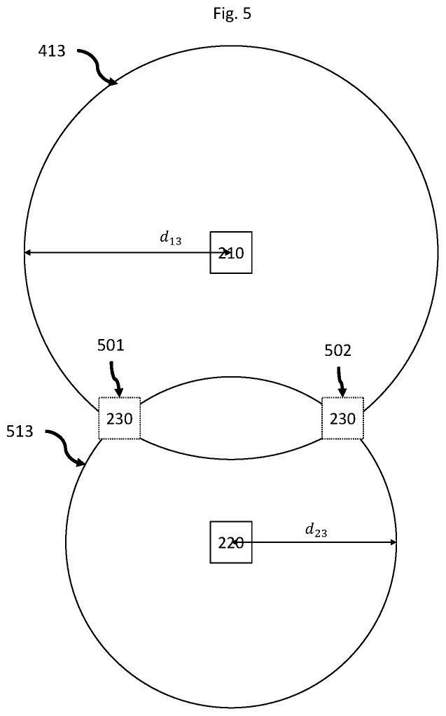

Further, as shown in FIG. 5, given d₁₃ and d₂₃, there are two possible positions 501 and 502 for the third communication node 230 with respect to the first communication node 210 and the second communication node 220, namely at the intersections of the two circles 413 and 513.

For k≥4, d₁ₖ may be chosen at will, d₂ₖ according to |d₁₂−d₁ₖ|≤d₂ₖ≤d₁₂+d₁ₖ and d₃ₖ according to a binary choice, i.e. between

$${d}_{3 k}^{1} and {d}_{3 k}^{2}$$

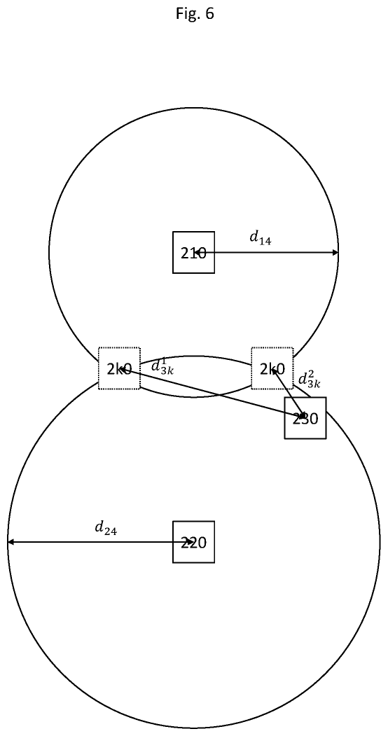

as shown in FIG. 6. All other distances, i.e., dₗₖ, 4≤l<k, are fully determined from the choices of d₁ₗ, d₂ₗ, and d₃ₗ, l≤k.

Summarizing, only the K−1 distances d₁ₖ, 2≤k≤K and the K−2 distances d₂ₖ, 3≤k≤K, i.e. 2K−3 distances, may be chosen freely. Considering the K internal clock errors ϵₖ, the total number of unknowns is 3 (K−1). As shown above, there are K(K−1)/2 measurements available. The unknowns may be determined if their number is less than the number of measurements, i.e. 3 (K−1)≤K(K−1). This implies K≥6.

Hence, in the absence of noise, it is possible to retrieve the true internal clock errors Ex from the measurements RTTᵢⱼ, 1≤i<j≤K whenever at least K=6 communication nodes are participating in positioning. In addition, the relative distances among the K communication nodes may be determined simultaneously. Further measurements may allow for taking translation, rotation and mirroring into account and, thus, obtaining location estimates for the communication nodes.

In the noise case, the K internal clock errors ϵₖ may be estimated as follows

$${\{ {\hat{ϵ}}_{k} \}}_{k = 1}^{K} = arg {min}_{{ϵ}_{1} , … , {ϵ}_{K}} {min}_{\{ {d}_{i j} \} ∈ {𝒟}_{K}} {\sum }_{i , j} {\vert {RTT}_{i j} - \frac{2 {d}_{i j}}{c} - {ϵ}_{i} - {ϵ}_{j} \vert}^{p}$$

where p is arbitrary (typically p=2 is used), and [symbol] _{K} represents the set of all possible distances among K points. Whenever K≥6, there is no error floor present, for the global optimal solution to the above optimization problem, as the variance of the noise variables nᵢⱼ vanishes.

The above considerations have been based on the assumption that the K communication nodes are essentially located in a two dimensional plane. A similar approach reveals that the K internal clock errors Ex may be determined if K≥8 communication nodes are used for the three dimensional case. As long as relative distances between the K communication nodes are larger than approximately 10 to 50 times the elevation distances, K≥6 communication nodes may be sufficient to estimate the internal clock errors.

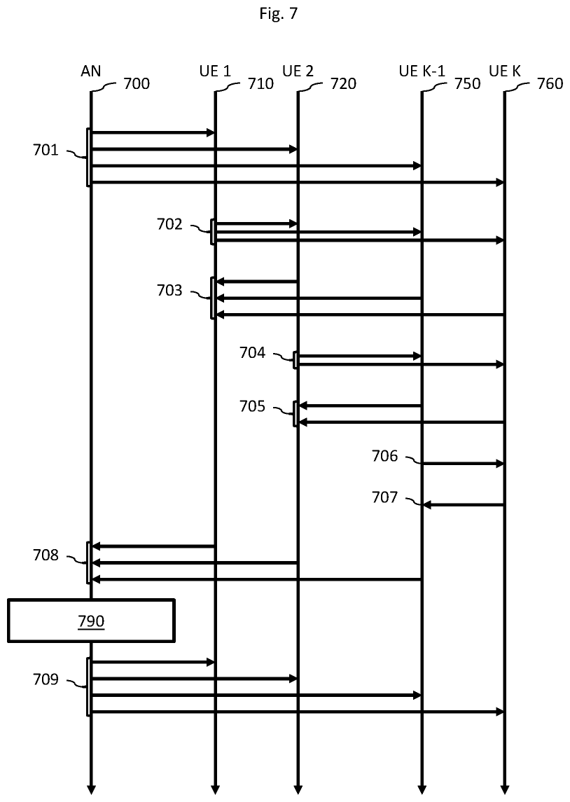

FIG. 7 is a signaling diagram illustrating signaling which may be used in a communication network for positioning. In particular, FIG. 7 illustrates a method performed by an operating node 700 of a communication network. The communication network comprises a plurality of communication nodes 700, 710, 720, 750, 760 including the operating node 700.

The communication nodes 700, 710, 720, 750, 760 may communicate with each other using a predefined protocol. In particular, the communication nodes may communicate with each other using a protocol as specified by 3GPP.

The communication nodes 710, 720, 750, 760 may be implemented by UEs and the operating node 700 may be implemented by an AN. However, it is also conceivable that the operating node 700 is implemented by a UE as well. In particular, the operating node 700 may be one of the UEs for which a clock error is to be estimated.

The operating node 700 may provide messages 701 to the communication nodes 710, 720, 750, 760 causing, in particular triggering, the communication nodes 710, 720, 750, 760 to perform time of flight related measurements. In FIG. 700 the operating node 700 is shown as an entity separate from the communication nodes 710, 720, 750, 760 which are to perform time of flight related measurements. However, it is also conceivable that one of the communication nodes 710, 720, 750, 760 is the operating node 700 and causes itself and the other communication nodes to perform the time of flight related measurements.

The messages 701 may be indicative of resources, in particular time and/or frequency resources, to be allocated for performing the time of flight related measurements. For example, the messages 701 may be indicative of resources, in particular time and/or frequency resources, to be used for reference signals to be communicated between the communication nodes 710, 720, 750, 760 for time of flight related measurements. Further, the messages 701 may be indicative of resources, in particular time and/or frequency resources, to be used for responses to the reference signals.

The communication node 710 transmits, in particular broadcasts, a reference signal 702 on a radio channel. The other communication nodes 720, 750, 760 receive the respective reference signal 702 and transmit respective K−1 response signals 703 to the communication node 710. This allows the communication node 710 to derive the ToF (or the RTT, i.e. two times the ToF) of the reference signal 702 to the other communication nodes 720, 750, 760 as has been explained above.

Then, the communication node 720 transmits, in particular broadcasts, a reference signal 704 on the radio channel. The communication nodes 750, 760 receive the respective reference signal 705 and transmit respective response signals 705. This continues until finally the communication node 750 transmits, in particular broadcasts, the reference signal 706 and receives the response signal 707 from the communication node 760.

The operating node 700 obtains, from at least six of the communication nodes 710, 720, . . . , 750, 760, a message 708 indicative of a ToF of a reference signal received by the respective communication node from the other communication nodes. If the operating node is implemented by one of the communication nodes 710, 720, . . . , 750, 760, obtaining a message indicative of a ToF of a reference signal may include obtaining said information from itself.

At 790, the operating node 700 may derive the clock error estimates of the communication nodes as has been explained hereinbefore.

The operating node 700 may provide, to at least one of the six communication nodes 710, 720, . . . , 750, 760, a message 709 indicative of a clock error estimate of the at least one of the six communication nodes.

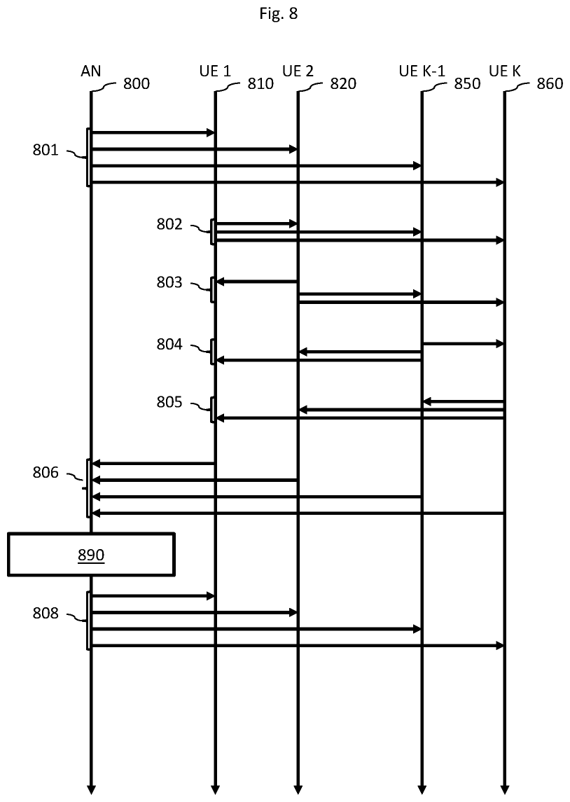

FIG. 8 is a further signaling diagram illustrating signaling which may be used in a communication network for positioning purposes. In particular, FIG. 8 illustrates a method performed by an operating node 800 of a communication network. The communication network comprises a plurality of communication nodes 800, 810, 820, 850, 860 including the operating node 800.

The communication nodes 800, 810, 820, . . . , 850, 860 may communicate with each other using a predefined protocol. In particular, the communication nodes may communicate with each other using a protocol as specified by 3GPP.

The communication nodes 810, 820, . . . , 850, 860 may be implemented by UEs and the operating node 800 may be implemented by an AN. However, it is also conceivable that the operating node is implemented by a UE as well.

The operating node 800 may provide messages 801 to the communication nodes 810, 820, . . . 850, 860 causing, in particular triggering, the communication nodes 810, 820, . . . , 850, 860 to perform time of flight related measurements. In FIG. 8 the operating node 800 is shown as an entity separate from the communication nodes 810, 820, . . . , 850, 860 which are to perform time of flight related measurements. However, it is also conceivable that one of the communication nodes 810, 820, . . . , 850, 860 is the operating node and causes itself and the other communication nodes to perform the time of flight related measurements.

The communication nodes 810, 820, . . . , 850, 860 transmit, in particular broadcast, reference signals 802, 803, 804, 805. The communication nodes 820, . . . , 850, 860, 810 may derive the time difference between a point in time of receiving a specific reference signal from another communication node and the point in time of transmitting, in particular broadcasting, its own reference signal. The time differences may be indicative of a time of flight of a reference signal received from the other communication node as will be explained further below.

In some scenarios, the reception of a reference signal by a particular communication node may trigger said communication node to transmit itself a reference signal.

The operating node 800 obtains from at least six of the communication nodes messages 806 indicative of a time of flight of a reference signal received by the respective communication node from the other communication modes.

In particular, UE i, 1≤i≤K−1 may report time durations from a point in time at which the UE i transmits its reference signal to a point in time it receives a reference signal from UE j>i and UE i, 2≤i≤K may report time durations from a point in time at which UE i receives a reference signal from UE j<i to a point in time UE i transmits its own reference.

Further, the operating node 800 provides, to at least one of the six communication nodes, a message indicative of a clock error estimate of the at least one of the six communication nodes.

According to some examples, the operating node 800 may obtain from at least eight of the communication nodes a message indicative of a time of flight of a reference signal received by the respective communication node from the other communication nodes. This may facilitate deriving the clock error estimate in case the elevation of the communication nodes differs substantially.

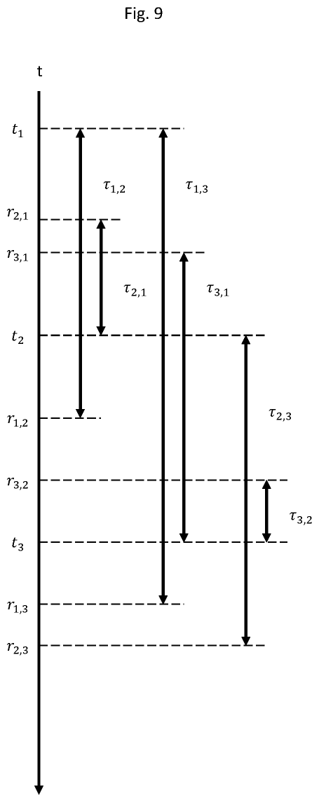

FIG. 9 serves to illustrates that the time differences may be indicative of the times of flight of reference signals communicated between the different communication nodes.

The communication nodes i broadcast the reference signals at a point in time tᵢ, respectively. The communication nodes j may receive the respective reference signals at rⱼᵢ, wherein the index i denotes the communication node transmitting the reference signal and the index j the communication node receiving the reference signal. Each communication node may determine the time difference τⱼᵢ=rⱼᵢ−tⱼ and the operator node may obtain the values of t from the respective communication nodes.

Thus, the operator node may derive the round trip time between the communication node i and the communication node j as RTTᵢⱼ=|τ_{i,j}−τ_{j,i}|.

Compared to the scenario described with respect to FIG. 7, the scenario of FIGS. 8 and 9 may require less resources, in particular time and/or frequency resources, for transmitting response signals and/or messages indicative of a time of flight of a reference signal.

Summarizing, at least the following EXAMPLES have been described above:

EXAMPLE 1. A method performed by an operating node of a communication network, the communication network comprising a plurality of communication nodes including the operating node, in particular a plurality of communication nodes communicating according to a predefined protocol, the method comprising:
obtaining, from at least six, in particular from at least eight, of the communication nodes, a message indicative of a time of flight of a reference signal received by the respective communication node from the other communication nodes,
providing, to at least one of the six, in particular eight, communication nodes, a message indicative of a clock error estimate of the at least one of the six, in particular eight, communication nodes.

EXAMPLE 2. The method of EXAMPLE 1,
wherein the message indicative of a time of flight of a reference signal is indicative of a time difference between a point in time of receiving the reference signal and a point in time of transmitting, in particular broadcasting, another reference signal by the respective communication nodes.

EXAMPLE 3. The method of EXAMPLE 1 or 2, further comprising:
deriving the clock error estimate from the six, in particular eight, messages indicative of the time of flight of the reference signal.

EXAMPLE 4. The method of any one of EXAMPLEs 1 to 3, further comprising
deriving the number of communication nodes from which a message indicative of a time of flight of a reference signal is received,
deriving the clock error estimate from the messages indicative of the time of flight of the reference signal and the number of communication nodes from which the messages are received.

EXAMPLE 5. The method of any one of EXAMPLEs 1 to 4,
wherein the operating node is an access node, AN.

EXAMPLE 6. The method of any one of EXAMPLEs 1 to 4,
wherein the operating node is a wireless communication device, UE.

EXAMPLE 7. A method performed by a wireless communication device of a communication network,
the communication network comprising a plurality of communication nodes including the wireless communication device and an operator node, in particular a plurality of communication nodes communicating according to a predefined protocol, the method comprising:
   upon receiving a reference signal, transmitting another reference signal; and
   providing, to the operator node, a message indicative of a time of flight of the received reference signal,
wherein the message indicative of a time of flight of a reference signal is indicative of a time difference between the point in time of receiving the reference signal and a point in time of transmitting the another reference signal.

EXAMPLE 8. An operator node comprising control circuitry,
wherein the control circuitry is configured to perform a method according to any one of EXAMPLEs 1 to 6.

EXAMPLE 9. A wireless communication device comprising control circuitry,
wherein the control circuitry is configured to perform the method of EXAMPLE 7.

1. A method performed by an operating node of a communication network, the communication network comprising a plurality of communication nodes including the operating node the method comprising:
obtaining, from at least six of the communication nodes, a message indicative of a time of flight of a reference signal received by the respective communication node from the other communication nodes,
providing, to at least one of the six communication nodes, a message indicative of a clock error estimate of the at least one of the six communication nodes.

2. The method of claim 1,
wherein the message indicative of a time of flight of a reference signal is indicative of a time difference between a point in time of receiving the reference signal and a point in time of transmitting another reference signal by the respective communication nodes.

3. The method of claim 1, further comprising:
deriving the clock error estimate from the six messages indicative of the time of flight of the reference signal.

4. The method of claim 1, further comprising
deriving the number of communication nodes from which a message indicative of a time of flight of a reference signal is received,
deriving the clock error estimate from the messages indicative of the time of flight of the reference signal and the number of communication nodes from which the messages are received.

5. The method of claim 1,
wherein the operating node is an access node, AN.

6. The method of claim 1,
wherein the operating node is a wireless communication device, UE

7. A method performed by a wireless communication device of a communication network, the communication network comprising a plurality of communication nodes including the wireless communication device and an operator node, the method comprising:
upon receiving a reference signal, transmitting another reference signal; and
providing, to the operator node, a message indicative of a time of flight of the received reference signal,
wherein the message indicative of a time of flight of a reference signal is indicative of a time difference between the point in time of receiving the reference signal and a point in time of transmitting the another reference signal.

8. An operator node comprising control circuitry,
wherein the control circuitry is configured to perform a method according to claim 1.

9. A wireless communication device comprising control circuitry,
wherein the control circuitry is configured to perform the method of claim 7.
